(19) United States
(12) Patent Application Publication
(10) Pub. No.: US 2018/0232734 A1
(43) Pub. Date: Aug. 16, 2018

(54) Systems and Methods for Use in Initiating Payment Account Transactions

(71) Applicant: MASTERCARD INTERNATIONAL INCORPORATED, Purchase, NY (US)

(72) Inventors: Patrik Smets, Nijlen (BE); Marc Van Puyvelde, Bornem (BE); Paul Vanneste, Ottignies (BE); Johan Gerber, Wildwood, MO (US)

(21) Appl. No.: 15/429,524

(22) Filed: Feb. 10, 2017

(51) Int. Cl. G06Q 20/40; G06Q 20/32

(52) U.S. Cl. CPC G06Q 20/401; G06Q 20/32

(57) ABSTRACT

Disclosed are exemplary embodiments of systems and methods for enabling Internet of Things (IoT) devices to initiate payment transactions. In an exemplary embodiment, a method generally includes receiving, by a computing device, a transaction request associated with a merchant where the transaction request includes a device identifier for an IoT device associated with a consumer and/or a location of the IoT device, and retrieving, by the computing device, a payment credential associated with a payment account when the transaction request is authenticated. The method also includes causing, by the computing device, the payment credential to be sent to the IoT device associated with the device identifier, whereby the IoT device is able to direct the merchant to proceed in the transaction using the payment credential.

### FIELD

The present disclosure generally relates to systems and methods for use in initiating payment account transactions and, in particular, for use in enabling Internet of Things (IoT) devices to initiate such payment account transactions.

### BACKGROUND

This section provides background information related to the present disclosure which is not necessarily prior art.

Payment account transactions are known mechanisms for consumers to fund purchases of products (e.g., goods and services, etc.) from merchants. To initiate the transactions, consumers present payment account credentials to the merchants. Typically, in performing such transactions, the consumers are authenticated to their payment accounts through signatures, personal identification numbers (PINs), biometrics, or other means. Separately, many devices are equipped with network connectivity technology, enabling them to connect to each other and to the Internet, thereby generally forming the “Internet of Things” (IoT). Such devices may include, for example, refrigerators, washing machines, televisions, automobiles, etc. As can be seen, in many cases, these devices have primary purposes or functionality unrelated to the transfer of data over a network.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in enabling Internet of Things (IoT) devices to initiate payment account transactions;

FIG. 2 is a block diagram of a computing device suitable for use in the exemplary system of FIG. 1;

FIG. 3 is an exemplary method, which may be implemented in connection with the system of FIG. 1, for registering an IoT device with an IoT server (or an IoT application) in order to enable the IoT device to initiate payment account transactions; and

FIG. 4 is an exemplary method, which may be implemented in connection with the system of FIG. 1, for authenticating an IoT device based on a transaction request and then transmitting a payment account credential to the IoT device for use in initiating a payment account transaction.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

The “Internet of Things” (IoT) generally refers to the concept of connecting various devices to the Internet and to each other. Such devices may include, without limitation, cellphones, coffee makers, headphones, lamps, wearable devices, refrigerators, washing machines, televisions, vehicles, etc. Uniquely, the systems and methods herein enable such IoT devices to perform payment account transactions. In particular, an IoT application (or an IoT server) is used to register IoT devices for use with particular payment accounts. The IoT application, then, presents an interface to registered IoT devices from which the IoT devices may request payment credentials (for their associated payment accounts) with which to perform payment account transactions. The IoT application authenticates the requests from the IoT devices based on a variety of security techniques such as, for example, identifier authentication based on knowledge of a symmetric or private key (broadly, cryptographic material), etc. Once a transaction request is authenticated for an IoT device, the IoT application may then check transaction rules and perform fraud checks based on the request. If the rules and checks pass, the IoT application then retrieves payment credentials for the associated payment account and transmits the payment credentials to the requesting IoT device, enabling the IoT device, then, as a payment device to perform a payment account transaction using the payment credentials. As such, the payment account transaction can be conveniently performed by the IoT device in a secure manner and without need to digitize the payment credentials into the IoT device.

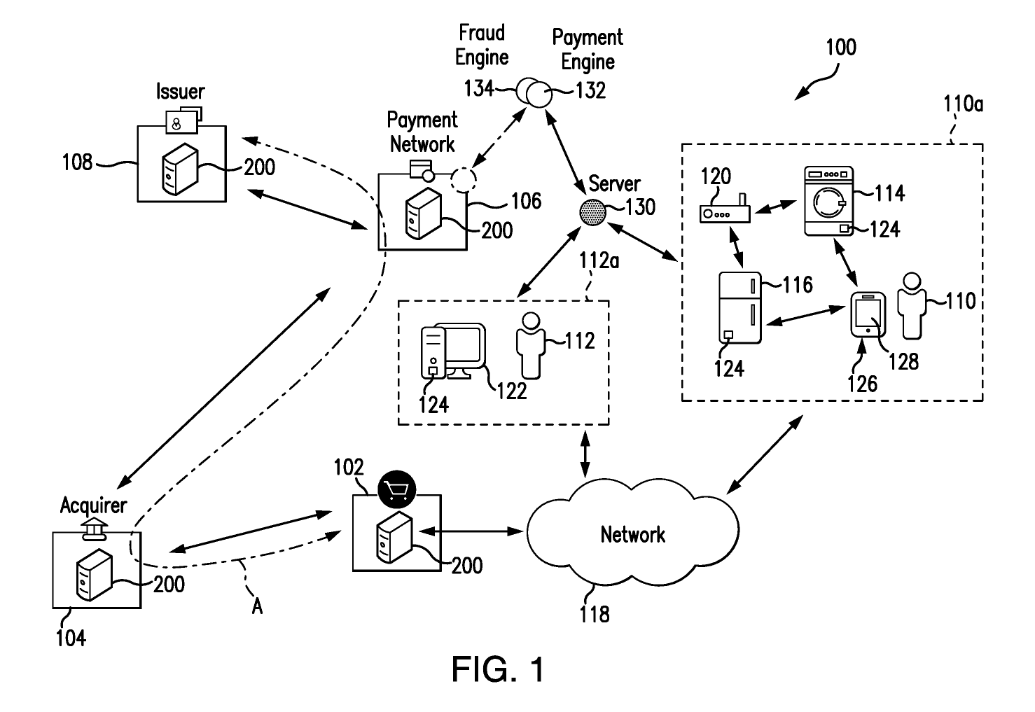

FIG. 1 illustrates an exemplary system 100 in which one or more aspects of the present disclosure may be implemented. Although, in the described embodiment, the system 100 is presented in one arrangement, other embodiments may include the system 100 arranged otherwise, depending, for example, on manners in which payment account transactions are initiated and/or executed by IoT devices, manners in which such payment account transactions are processed, etc.

Referring to FIG. 1, the system 100 includes a merchant 102 (or merchant server), an acquirer 104 associated with the merchant 102, a payment network 106, and an issuer 108 of payment accounts, each coupled to (and in communication with) one or more networks. The networks are represented by the solid arrowed lines in FIG. 1, and may each include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In addition, the multiple networks may be accessible to different ones of the illustrated parts in FIG. 1 (even if illustrated as being between two specific parts of the system 100). In this example, a private payment transaction network is made accessible by the payment network 106 to the acquirer 104 and the issuer 108 and, separately, a public network (e.g., the Internet, etc.) is provided for communication between the merchant 102 and the acquirer 104 (e.g., via a website or via network-based applications, etc.) or through which consumers 110 and 112 may communicate.

Generally in the system 100, the merchant 102 offers products (e.g., goods and/or services, etc.) for sale to consumers, including the consumers 110 and 112, through a virtual storefront, such as, for example, a merchant website (broadly, a network-based application), etc. In connection therewith, the consumers 110 and 112 are each associated with a payment account, which may be used to fund purchases for such products at the merchant 102. In the illustrated embodiment, the payment accounts are issued to the consumers 110 and 112 by the issuer 108 (however, this is not required in all embodiments), and are each associated with a payment device (e.g., a payment card, a fob, a payment application, etc.).

In an example transaction at the merchant 102, by the consumer 110, for example, the consumer 110 presents payment credentials associated with his/her payment account (e.g., a primary account number (PAN), account owner name, expiration date, card verification value (CVV), token, etc.) to the merchant 102 (directly or via the payment device associated with the consumer's account). In addition to the credentials, the consumer 110 may further be prompted to provide one or more forms of authentication, such as, a password, a PIN, a biometric, etc.

In turn in the example transaction, the merchant 102 reads/receives the payment credentials for the consumer's payment account. As is conventional, the merchant 102 then causes an authorization request, for the transaction (including the credentials and product details), to be transmitted to the acquirer 104, along path A in the system 100. Upon receipt, the acquirer 104 communicates the authorization request with the issuer 108 through the payment network 106, such as, for example, through MasterCard®, VISA®, Discover®, American Express®, etc. The issuer 108 determines whether the consumer's payment account is in good standing and whether there are sufficient funds and/or credit to fund the transaction. If approved, an authorization reply, or response (indicating the approval of the transaction), is transmitted back from the issuer 108 to the merchant 102 again along path A, thereby permitting the merchant 102 to complete the transaction. The transaction is later cleared and/or settled (via appropriate transaction messages such as clearing messages and/or settlement messages, for example) by and between the merchant 102, the acquirer 104, and the issuer 108 (by appropriate agreements). If the transaction is declined, however, an authorization reply (indicating the decline of the transaction) is provided back to the merchant 102, thereby permitting the merchant 102 to halt or terminate the transaction, or request alternate funding.

Transaction data is generated, collected, and stored as part of the above interactions among the merchant 102, the acquirer 104, the payment network 106, the issuer 108, and the consumer 110. The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.), but could be stored in other parts of the system 100. Additionally, or alternatively, transaction data may be transmitted among parts of the system 100 as desired and/or necessary. As used herein, transaction data may include, for example (and without limitation), primary account numbers (PANs) for accounts involved in the transactions, amounts of the transactions, merchant IDs for merchants involved in the transactions, merchant category codes (MCCs), dates/times of the transactions, geo-locations of the transactions, device identifiers of IoT devices involved in the transactions, etc. It should be appreciated that other information related to transactions may be stored within the system 100, in particular at the payment network 106, aside from the authorization or clearing data, as well.

In various exemplary embodiments, consumers (e.g., consumers 110 and 112, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions herein, subsequently for one or more of the different purposes described herein.

Also in the system 100, the consumer 110 may dispute a transaction (or charge) to his/her payment account, for example, involving the merchant 102, etc. for one or more reasons (e.g., the consumer 110 did not receive the purchased product from the merchant 102, or believes the received product is defective or damaged; the amount charged to the consumer's payment account for the transaction is incorrect; the consumer 110 does not recognize, or did not make, a payment transaction with the merchant 102 processed to his/her payment account, or was a victim of fraud; the consumer 110 simply wishes to return the purchased product; etc.). In so doing, the consumer 110 initially interacts with the issuer 108 to initiate a request (or claim) for a refund of the amount of the disputed transaction (e.g., provides payment account details to the issuer 108 directly or via the payment device associated with the consumer's account, details of the reason for making the request, etc.). The issuer 108 may then investigate the disputed transaction (and associated refund request), and transmit the disputed transaction/refund request to the acquirer 104 (and the merchant 102) through the payment network 106, as a chargeback transaction. If appropriate, the issuer 108 re-posts the transaction to the consumer's payment account. Otherwise, the acquirer 104 removes the disputed amount from the merchant's account (such that the merchant 102 suffers the loss), and reconciles as needed with the issuer 108.

With continued reference to FIG. 1, the consumer 110 in the system 100 is associated with IoT devices 114 and 116 (illustrated as a washing machine and a refrigerator, respectively) at a location 110a (e.g., a residence of the consumer 110, etc.). The IoT devices 114 and 116 are coupled to (and are in communication with) a network 118 associated with the merchant 102 for sending and/or receiving data to/from the merchant 102, via the network 118. In connection therewith, the IoT devices 114 and 116 may be in direct communication with the network 118, or such communication may be via a router 120. The network 118 may include, without limitation, a wired and/or wireless network, a local area network (LAN), a wide area network (WAN) (e.g., the Internet, etc.), a mobile network, and/or another suitable public and/or private network capable of supporting communication among the IoT devices 114 and 116 (and other IoT devices) and the merchant 102. And, through such connection, the IoT devices 114 and 116 may interact with the merchant 102 (via the network 118) to identify products from the merchant 102 to purchase and to perform purchase transactions for such products (as a payment device), as described above. Further, through such connection, in various embodiments, the IoT devices 114 and 116 may also receive product information or other data from the merchant 102, receive advertising data, receive coupons, etc.

Similarly, the consumer 112 is associated with IoT device 122 (illustrated as a television) at a location 112a (e.g., a residence of the consumer 112, etc.). The IoT device 122 is also coupled to (and is in communication with) the network 118 for exchanging data via the network 118 with the merchant 102 in a similar manner to that described above.

In particular in the illustrated embodiment, the devices 114 and 116 associated with the consumer 110 are coupled to the network 118 via the router 120 (as indicated by the arrows in FIG. 1), while the device 122 associated with the consumer 112 is coupled to the network 118 independent of any router (e.g., directly or otherwise, etc.). With that said, it should be appreciated that IoT devices, as used herein, may include any desired devices having ability to connect to the network 118 and/or to other devices (and, generally, having one or more functionalities other than enabling purchase of products via transactions). Example IoT devices include, without limitation, cellphones, coffee makers, washing machines, headphones, lamps, wearable devices, vehicles, televisions, refrigerators, etc.

Also in the system 100, the IoT devices 114 and 116 each include an application 124 configured (e.g., via computer executable instructions, etc.) to interact with a communication device 126 (e.g., a smartphone, a tablet, etc.) associated with the consumer 110, and more particularly with an IoT application 128 on the consumer's communication device 126. This allows the IoT devices 114 and 116 to exchange data with the communication device 126 (e.g., so that the IoT devices 114 and 116 can be used as payment devices to effect payment account transactions as described herein (e.g., as described in the example transaction above, etc.), etc.). In addition, or alternatively, the applications 124 at each of the IoT devices 114 and 116 may be configured to interact with an IoT server 130, so that IoT devices 114 and 116 can exchange data with the IoT server 130. Similarly, the IoT device 122 includes an application 124 configured to interact with the IoT server 130 so that the IoT device 122 and the IoT server 130 can exchange data (e.g., so that the IoT device 122 can be used as a payment device to effect payment account transactions as described herein (e.g., as described in the example transaction above, etc.), etc.). With that said, the application 124, regardless of the particular ones of the IoT devices 114, 116, and 122 in which it is included, generally includes a software integrity protection mechanism to avoid software manipulation and malware, and to protect confidentiality of any keys used for authentication (which is described in more detail hereinafter).

Regarding the consumer 110, the communication device 126 associated with the consumer 110 may hold or be connected to a payment engine 132. The payment engine 132 is configured to provide the communication device 126 (and the IoT application 128) access to payment credentials managed thereby (e.g., for the consumer's payment account, for other payment accounts, etc.). Prior to providing such credentials, the payment engine 132 may prompt the consumer 110 to provide one or more forms of authentication, such as, a password, a PIN, a biometric, etc. In addition, the communication device 126 may be used in combination with the IoT devices 114 and 116, as generally described above, and may be coupled to (and in communication with) the network 118 as desired, for example, directly (e.g., via Wi-Fi, Near-Field Communication (NFC), Bluetooth, etc.), or via the router 120, or via a cellular network (not shown), etc.

The IoT application 128 on the communication device 126 associated with the consumer 110 is configured (e.g., via computer-executable instructions, etc.) to register the IoT devices 114 and 116 therewith, through the applications 124 at the IoT devices 114 and 116. In connection therewith, the IoT application 128 is configured to provide device identifiers to the IoT devices 114 and 116 (e.g., for use in subsequently identifying the devices 114 and 116 in payment account transactions, etc.). In addition, the IoT application 128 is configured to perform a key exchange with the IoT devices 114 and 116 for device authentication and encryption of the data transferred there between, for instance, payment credentials received from the payment engine 132, etc., to enhance security.

Subsequently, the IoT application 128 is configured to refresh the keys in the IoT devices 114 and 116 at regular intervals (i.e., key rotation), for instance each time the communication device 126 comes into the proximity of one (or both) of the IoT devices 114 and 116. Alternatively (or additionally), the keys may be refreshed based on a predefined time interval (e.g., based on elapse of a predefined time upon which the key expires, etc.), or based on a number of payment account transaction completed using the particular IoT device having the key (e.g., based on a velocity check, etc.). In any case, in refreshing the key, the communication device 126 authenticates itself to the IoT devices 114 and 116 using the current keys and, upon successful authentication, the IoT devices 114 and 116 install the new key as exchanged with (or received from) the IoT application 128. The initiative to refresh the keys may be taken by the consumer's communication device 126 (e.g., by the IoT application 128, etc.), or it may be taken by the IoT devices 114 and 116. As can be appreciated, refreshing (or rotating) the keys frequently may make it more difficult for a fraudster to get hold of the keys and impersonate one of the IoT devices 114 and 116. It will be appreciated that such key rotation may be performed automatically, without interaction from the consumer 110. In certain embodiments, installing updated cryptographic data at the IoT device may be based on the cryptographic data already stored at the IoT device.

Additionally, the IoT application 128 is configured to receive transaction requests from the IoT devices 114 and 116, once registered (e.g., purchase transaction requests, refund transaction requests, etc.). The transaction requests may include, for example, the device identifiers of the associated IoT devices 114 and 116 making the request (as provided to the IoT devices 114 and 116 by the IoT application 128), and a message authentication code generated with the key(s) set up at registration of the IoT devices 114 and 116 (and subsequently refreshed, as appropriate). Alternatively (or additionally), the transaction requests may include a location of the IoT devices 114 and 116 (e.g., at location 110a, etc.) to help identify the IoT devices 114 and 116 and, potentially, authenticate them. The IoT application 128 is configured to then authenticate the transaction requests for the IoT devices 114 and 116 based on their device identifiers, their location, and/or their message authentication code. When a transaction request is authenticated for the IoT device 114, for example, the IoT application 128 is configured to retrieve payment credentials associated with the consumer's payment account, from the payment engine 132, and provide the retrieved credentials to the IoT device 114, for example, for use in a payment account transaction associated with the request (e.g., in connection with a purchase of products at the merchant 102 via the network 118, etc.).

In connection with such transaction requests, in various embodiments the IoT application 128 may be configured to create, store, and implement transaction rules associated with the IoT devices 114 and 116, the consumer's payment account, and/or aspects of associated transactions initiated by the IoT devices 114 and 116 and/or involving the consumer's payment account. Further, the IoT application 128 may be configured to evaluate the transaction requests and/or aspects of the transaction requests received from the IoT devices 114 and 116 using the transaction rules and, based thereon, determine whether to provide the payment credentials to the IoT devices 114 and 116. Moreover, the IoT application 128 may be configured to notify or otherwise contact the consumer 110 regarding received transaction requests, and to withhold payment credentials from the associated IoT devices 114 and 116 until confirmation and/or authentication from the consumer 112 is received.

With still continued reference to FIG. 1, as an alternative to the IoT application 128, the system 100 includes the IoT server 130 configured (e.g., via computer-executable instructions, etc.) to interact with IoT devices (e.g., with IoT devices 114 and 116, etc.) in substantially the same manner as the IoT application 128. For example, in the system 100, the consumer 110 may not have access to his/her communication device 126, or the consumer may simply desire not to use the IoT application 128. In such an example, the IoT server 130 is configured to interact with the IoT devices 114 and 116, in the manner described above for the IoT application 128, so that the devices 114 and 116 can still be used as payment devices to effect payment account transactions as described herein (e.g., as described in the example transactions above, etc.). As described next, this also applies to the IoT device 122 associated with the consumer 112.

Regarding the consumer 112 (who may not have a communication device, or may not have the IoT application 128 on his/her communication device), the IoT server 130 is configured to perform substantially the same operations as the IoT application 128 in connection with the IoT device 122. As such, the various operations described above in connection with the IoT application 128 will not be repeated. However, in contrast to the IoT application 128, the IoT server 130 is stored, implemented, and/or executed apart from any communication device. For example, in the illustrated embodiment, the IoT server 130 is illustrated as a standalone part of the system 100. However, in other embodiments, the IoT server 130 may be implemented in one or more parts of the system 100 (e.g., the payment network 106, etc.), or in other parts of other system embodiments (e.g., in connection with one or more service providers that interact with different parts of the system 100; in connection with different payment networks; etc.), or the like.

With that said, it should be appreciated that the IoT server 130 may also be configured to offer various network connections and/or interfaces to access the various operations and/or services provided thereby (e.g., from other computing devices over a network, etc.). For instance, the IoT server 130 may be configured to register the IoT device 122, for example, based on instructions received from a different computing device over a network connection and/or interface. Similarly, the IoT server 130 may be configured to implement and/or execute the operations described above with respect to the IoT application 128 in response to instructions received from different computing devices and/or IoT devices over network connections and/or interfaces.

Again, while the IoT application 128 is described above in association with the IoT devices 114 and 116, it should be appreciated that, in some embodiments, the IoT server 130 or another IoT application may instead operate in association with the IoT devices 114 and 116. Similarly, while the IoT server 130 is generally described in association with the IoT device 122, it should be appreciated that, in some embodiments, an IoT application 128 may instead operate in association with the IoT device 122.

With further reference to FIG. 1, the system 100 includes the payment engine 132 and a fraud engine 134, each of which is configured, often by computer-executable instructions, to perform one or more of the various operations described herein. In the illustrated embodiment, the payment engine 132 and the fraud engine 134 are both implemented in the payment network 106, for example, in association with a computing device associated therewith (as indicated by the dotted lines in FIG. 1). However, in other embodiments, the payment engine 132 and/or the fraud engine 134 may be implemented in one or more other parts of the system 100 (e.g., the payment engine 132 may be implemented in the communication device 126 in the form of a virtual wallet application or the like while the fraud engine 134 is implemented in the payment network 106, etc.) or in other parts of other system embodiments (e.g., in connection with different payment networks, acquirers, issuers, etc.), or the like. Additionally, in still other embodiments, the payment engine 132 and/or the fraud engine 134 may be a standalone part of the system 100 (and consistent with computing device 200 described hereinafter), for example, in communication with the payment network 106 or other parts of the system 100 via one or more networks.

The payment engine 132 is configured to store and/or provide access to payment accounts and associated payment account data such as payment credentials, payment account owner information, account transaction history, and the like. In connection therewith, the payment engine 132 is configured to receive requests for payment credentials from the IoT application 128 and/or the IoT server 130 and to provide the requested payment credentials thereto (either back to the IoT application 128 and IoT server 130, or directly to the one(s) of IoT devices 114, 116, and 122 for which the credentials are requested). In so doing, the payment engine 132 is configured to enable the IoT devices 114, 116, and 122 as payment devices for use in payment account transactions (e.g., as described in the example transactions above relating to the purchase of products and/or relating to requests for refunds, etc.). For example, the payment engine 132 may be configured to provide transaction credentials through the support of Digital Secure Remote Payments (DSRP), Card-on-file in combination with SecureCode or the like. Non-limiting examples of payment engines may include MasterPass from MasterCard®, Android Pay, and Apple Pay from Apple®. Typically, payment accounts may be tokenized and digitized into these wallet applications, avoiding the need to put payment credentials in the IoT devices 114, 116, and 122.

Further, the payment engine 132 may be configured to enforce security and/or encryption schemes when providing the payment credentials to the IoT devices 114, 116, and 122; to the IoT application 128; and/or to the IoT server 130. For example, as described above, the payment engine 132 may be configured to enable DSRP or the like.

The fraud engine 134 of the illustrated system 100 is configured to detect patterns in transaction data that may indicate abnormal behavior (e.g., fraud behavior, etc.). In connection therewith, the fraud engine 134 is configured to receive transaction data (e.g., via the payment network 106, etc.) and analyze the received transaction data for such patterns. Further, the fraud engine 134 may be configured to deliver messages, notifications, or the like to other parts of system 100 in the event that abnormal behavior and/or abnormal patterns are detected. For instance, the fraud engine 134 may be configured to send a fraud notification to the IoT application 128 when recent transactions involving the consumer's payment account associated with the IoT application 128 form a pattern that indicates a high likelihood of fraudulent use of the payment account (e.g., a fraud score generated by or provided to the fraud engine 134 fails to satisfy a defined threshold, etc.). Further, the fraud engine 134 may be configured to cause one of the registered IoT devices 114 and 116 to be removed from registration at the IoT application 128 (or at the IoT server 130) based on detected fraud patterns and, in some cases, the fraud engine 134 may be configured to blacklist one or both of the IoT devices 114 and 116 (or the IoT device 122) such that it/they cannot be registered with the IoT application 128 and/or the IoT server 130 until a reason for the fraud pattern and/or fraud indication is remedied.

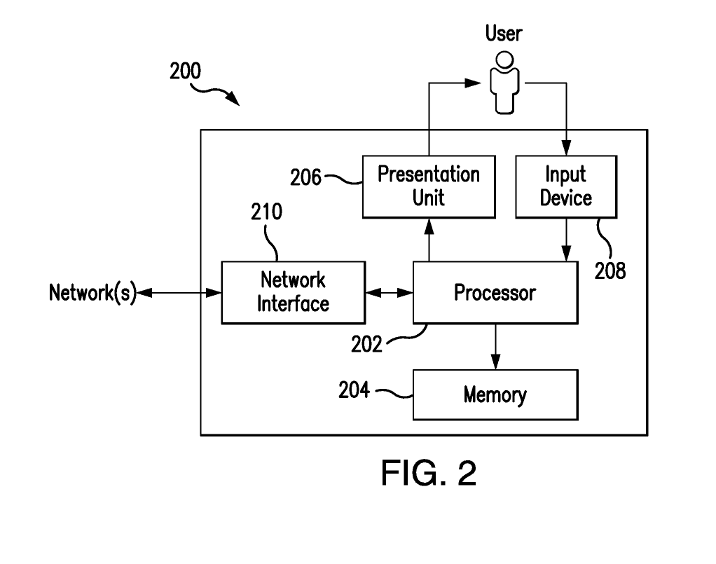

FIG. 2 illustrates an exemplary computing device 200 used in the system 100. The computing device 200 may include, for example, one or more servers, workstations, routers, personal computers, tablets, laptops, smartphones, PDAs, etc. In addition, the computing device 200 may include a single computing device, or it may include multiple computing devices located in close proximity or distributed over a geographic region, so long as the computing devices are specifically configured to function as described herein. In the system 100, each of the merchant 102, the acquirer 104, the payment network 106, and the issuer 108 are illustrated as including, or being implemented in, a computing device 200, coupled to a network. In addition, each of the IoT devices 114, 116, and 122, the router 120, the communication device 126, and the IoT server 130 may be considered a computing device, consistent with computing device 200. Further, the payment engine 132 and the fraud engine 134 may be considered a computing device, consistent with or implemented in computing device 200. However, the system 100 should not be considered to be limited to the computing device 200, as described below, as different computing devices and/or arrangements of computing devices may be used. In addition, different components and/or arrangements of components may be used in other computing devices.

The exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data/parameters, device identifiers, private/public keys, IoT application data, payment account data and/or credentials, and/or other types of data suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information, either visually or audibly to a user of the computing device 200 (e.g., to one or more of the consumers 110 and 112, etc.). In addition, it should be appreciated that various interfaces (e.g., as defined by conventional applications, network-based applications, etc.) (e.g., application(s) 124, IoT application 128, etc.) may be displayed at computing device 200, and in particular at presentation unit 206, to display such information to the user. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, by scanning/receiving device identifiers and/or receiving transaction confirmation inputs, etc. The input device 208 is coupled to (and is in communication with) the processor 202 and may include, for example, a keyboard, a pointing device, a mouse, a button, a stylus, a touch sensitive panel (e.g., a touch pad or a touch screen, etc.), a camera or other optical input device, another computing device, and/or an audio input device. Further, in various exemplary embodiments, a touch screen, such as that included in a tablet, a smartphone, or similar device, may behave as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter (e.g., a Wi-Fi adapter, a NFC adapter, a Bluetooth adapter, etc.), a mobile network adapter, or other device capable of communicating to/with one or more different networks, including those in the system 100. Further, in some exemplary embodiments, the computing device 200 includes the processor 202 and one or more network interfaces 210 incorporated into or with the processor 202.

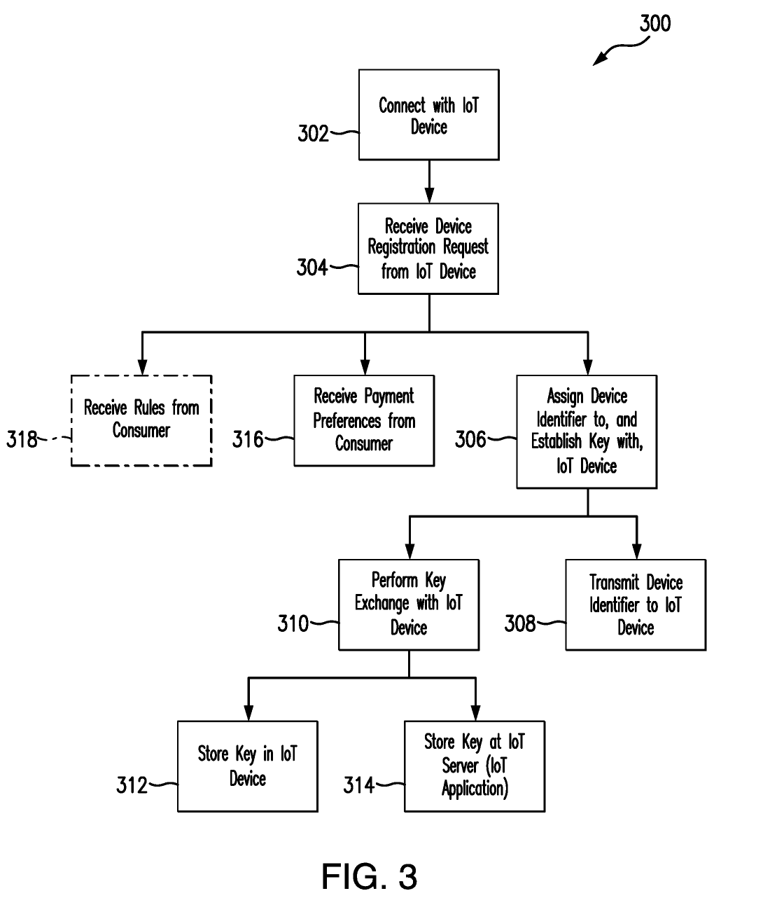

FIG. 3 illustrates exemplary method 300 for registering an IoT device for use as a payment device, so that the IoT device can be used to initiate a payment account transaction for the purchase of a product and/or for the return of a product (in the form of a refund transaction). The exemplary method 300 is described with reference to the system 100 and to the computing device 200. Nonetheless, it should be understood that the methods herein are not limited to the exemplary system 100, or the exemplary computing device 200, and similarly, the systems and the computing devices herein are not limited to the exemplary method 300.

More particularly, the method 300 is described as implemented in the IoT server 130 of the system 100, with reference to the IoT device 122 and its interaction with the IoT server 130. However, it should be appreciated that the method 300 equally applies to interaction between the IoT server 130 and the other IoT devices 114 and 116 of the system 100. Further, it should be appreciated that the description also applies to the IoT application 128 (e.g., the method 300 may be implemented in the IoT application 128, etc.), and interaction between the IoT application 128 and one or more of the IoT devices 114 and 116, for example.

With reference to FIG. 3, in connection with registering the IoT device 122 (via the application 124) to the IoT server 130 (and/or to the IoT application 128), the IoT device 122 (via the application 124) initially connects with the IoT server 130, at 302. This may be based on initiation of such registration by the IoT device 122. Or, this may be based on initiation of such registration by the IoT server 130 (and/or the IoT application 128, depending on the IoT device involved). In any case, the connection may be formed via a network (e.g., a wireless network connection, a Bluetooth connection, a network-based connection, etc.), and in some embodiments the connection may include intermediate entities, such as a router or the like (although such intermediate entities are not required). In response to the connection (regardless of the source of the initiation), the IoT device 122 confirms the connection and responds with various device data. The device data may include, without limitation, identifying information for the IoT device 122 such as serial number, model number, device brand, device name, etc. It should again be appreciated that interaction between the IoT devices 114 and 116 and the IoT application 128 (via the communication device 126) is substantially similar.

Next, the IoT server 130 receives a device registration request from the IoT device 122, at 304 (e.g., via an input device 208, etc.), for example, as initiated by the IoT device 122. In connection therewith, the IoT server 130 may cause an interface to display at the IoT device 122 and/or at a communication device associated with the consumer 112 requesting approval to register the device 122 to the application 128 (e.g., via a user input from the consumer 112 to the interface, etc.). Or, in some embodiments, the IoT server 130 may automatically initiate such registration.

In any case, at 306, the IoT server 130 assigns a device identifier to and establishes a key with the IoT device 122, based on the device data for the device 122. At 308, the IoT server 130 transmits the device identifier to the IoT device 122. And, at 310, the IoT server 130 initiates a key exchange with the IoT device 122, to establish the key at the IoT device 122. In connection with the key exchange, the IoT device 122 stores the key in the device 122 (e.g., in memory 204, etc.), at 312; and the IoT server 130 stores the key in the IoT server 130 (e.g., in memory 204, etc.), at 314. The device identifier and/or the key may be bound to hardware and/or software characteristics of the IoT device 122, as well as localization parameters (e.g., model, device ID, processor ID, hardware build version, processor type, screen size, software build, software version number, global positioning satellite (GPS) coordinates, etc.). If symmetric key cryptography is used, such operations (at 310-314), may be performed using the device identifier and other parameters (e.g., IoT device location, etc.) as key diversification factors. Alternatively, if public key cryptography is used, the device identifier and other parameters are included in a public key certificate.

The assigned device identifier, then, is used to identify the IoT device 122 during future payment account transactions and should be understood to be unique to the IoT device 122 with respect to the IoT server 130 (i.e., the IoT server 130 associates the assigned device identifier with only the IoT device 122, as long as it is registered with the IoT server 130). Alternatively (or additionally), a location of the IoT device 122 (e.g., at location 112a, etc.) may be used to identify the IoT device 122 during future payment account transactions. And, the key is used (as generally described above) in encryption and/or authentication schemes that may be implemented to enhance security of the subsequent payment account transactions and/or other communications between the IoT device 122, the IoT server 130, and, in some implementations of the method 300, the payment engine 132.

With continued reference to FIG. 3, in connection with registering the IoT device 122 to the IoT server 130 (or later), the IoT server 130 also receives preferences from the consumer 112, at 316, regarding the consumer's payment account(s) to be used in transactions initiated by the IoT device 114 (broadly, payment preferences). Such preferences do not generally control whether transactions take place or not, but instead provide guidance to processing the transactions based on the consumer's desires/input. In providing the preferences, the consumer 112 may provide payment account information and/or credentials for a particular payment account to be stored in the payment engine 132 for use as described herein, or the consumer 112 may select a payment account that is already stored in the payment engine 132 or other wallet application (e.g., a payment account stored in a payment application on a communication device associated with the consumer 112 to which the IoT server 130 may be linked, etc.). What's more, in providing the preferences, the consumer 112 may also (or alternatively) provide instructions regarding payment products to be used in the transactions, for example, credit accounts over debit accounts, corporate accounts over personal accounts (e.g., depending on the IoT device being used, etc.). For instance, for an IoT device including a company vehicle, the consumer 112 may provide an instruction to perform all transactions initiated by the company vehicle IoT device through the consumer's corporate account.

Also in connection with registering the IoT device 122 to the IoT server 130 (or later), the consumer 112 may, optionally, provide transaction rules to the IoT server 130 (again, via the consumer's communication device or via another computing device) that govern the approval of future transactions initiated by the IoT device 122 through the IoT server 130. Such rules may dictate whether or not the transactions take place. In turn, the IoT server 130, optionally (as indicated by the dotted lines in FIG. 3), receives such rules, at 318, and stores them in memory (e.g., memory 204, etc.) at the IoT server 130 and/or at the payment engine 132. Such rules may relate to parameters of a transaction, such as transaction amount, product quantity, product brand, product name, product category, merchant name and/or identifier, MCC, transaction location, date and time of the transaction, etc. For instance, a rule may be satisfied when a transaction amount is less than, greater than, equal to, etc. a defined threshold value, or when a particular merchant category such as “electronics” is involved (or not). Or, a rule may be satisfied when a transaction occurs within (or outside of) a defined time period, or when a transaction occurs within (or outside of) a defined area, location, or threshold distance/proximity to a defined location. For example, with regard to the IoT device 122, a rule may require a location of the IoT device 122 to be within the location 112a.

In response, when a rule is satisfied (or not satisfied), the transaction may be allowed to proceed, or the transaction may be cancelled (depending on the rule). Further, a notification may be sent to the consumer 112, by the IoT server 130 (e.g., via SMS, email, etc.), identifying the implicated rule and whether it is satisfied or not. In some implementations, as part of the notification, the IoT server 130 may also request the consumer 112 to confirm (or decline) the transaction identified therein. As an example, the consumer 112 may create a rule for the IoT device 122 (illustrated as a television in the system 100), which requires a MCC associated with movies or the like, in order for a transaction to proceed. As another example, the consumer 112 may create a rule for the IoT device 122 where transactions of greater than $50 cause a notification to be sent to the consumer 112 requiring confirmation by the consumer 112 for the transaction to proceed.

It should be appreciated that registration of the IoT devices 114 and 116 to the IoT application 128, for example, would be substantially similar to the registration of device 122 just described.

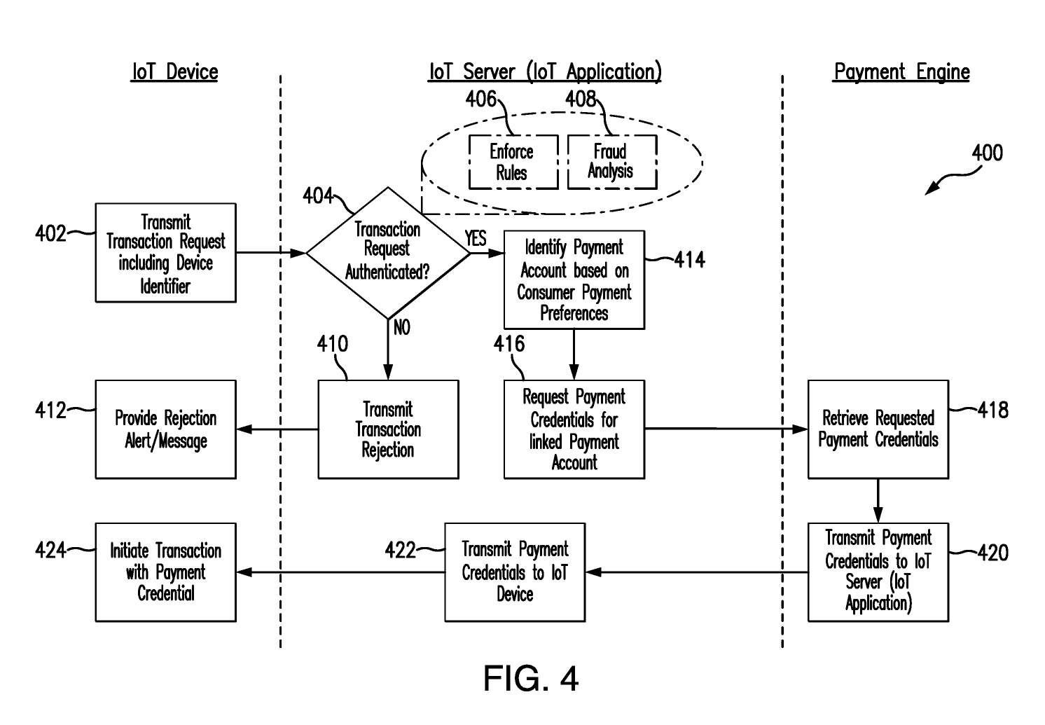

FIG. 4 illustrates exemplary method 400 for initiating a payment account transaction via a registered IoT device, whereby the registered IoT device is used as a payment device (e.g., in a purchase transaction for a product, in a refund transaction, etc.). The exemplary method 400 is again described with reference to the system 100 and to the computing device 200. Nonetheless, it should also again be understood that the methods herein are not limited to the exemplary system 100, or the exemplary computing device 200, and similarly, the systems and the computing devices herein are not limited to the exemplary method 400.

In method 400, the IoT device 122, having already been registered with the IoT server 130 (e.g., via method 300, etc.), sends (or transmits) a transaction request, including its device identifier (and/or location), to the IoT server 130, at 402. Such transaction request may relate to a purchase of products at the merchant 102, for example, as initiated by the IoT device 122 via the network 118. Or, it may relate to a request for a refund relating to a product previously purchased at the merchant 102 (or relating to a prior purchase transaction involving the merchant 102). It should be understood that, in some embodiments, the transaction request may further include a message authentication code, generated using the key established during registration for the IoT device 122 (and subsequently rotated), and other data that may be encrypted.

The transaction request may also include transaction parameters, such as those described above, (e.g., transaction amount, product quantity, product brand, product name, product category, merchant name and/or identifier, MCC, location of the transaction, date and time of the transaction, etc.), or the like. The transaction request may be sent over a network connection between the IoT device 122 and the IoT server 130, (e.g., a wireless network connection, an Internet connection, etc.), wherein the connection may include intermediate parts, such as a router and/or other servers, routers, switches, etc.

Upon receipt of the transaction request, the IoT server 130 evaluates the origin of the request and the authenticity and integrity of the data included therein, including the various parameters included in the transaction request, at 404. In connection therewith, the IoT server 130 may authenticate the device identifier (and/or device location) for the IoT device 122. Authenticating the device identifier may include, for example, accessing a listing of device identifiers stored by the IoT server 130 (e.g., in a data structure in memory 204, etc.) to determine whether the received device identifier is present (and that the IoT device 122 is registered). In addition, the IoT server 130 may also enforce any identified transaction rules, at 406 (e.g., as received from the consumer 112 at 318 in the method 300, etc.), and/or check the transaction request and/or transaction history of the associated payment account for indications of fraud, at 408. In other words, the IoT server 130 may perform one or more of the operations 406 and 408 to ultimately authenticate the device identifier (when the device identifier is present in the listing of registered device identifiers at the IoT server 130, for example).

Evaluating the transaction request against the transaction rules (at 406) may include retrieving all available transaction rules, from memory 204, and determining if any are implicated. For instance, if a transaction rule requires that the transaction be for less than a threshold value of $50 to proceed and the current transaction request includes a transaction amount of $100 (broadly, a transaction parameter), the transaction rule is not satisfied and the IoT server 130 declines to authenticate the transaction request for the IoT device 122. However, if the transaction amount is $25 instead, the IoT server 130 may authenticate the transaction request, assuming all other rules and/or requirements are met. In another example, a transaction rule may require that the consumer 112 confirm any transaction over $50 prior to the transaction proceeding. Here, if the transaction amount is $100, the consumer 112 may receive a notification at his/her communication device (or other computing device), from the IoT server 130, and the IoT server 130 may wait until a confirmation is received from the consumer 112 before proceeding with the transaction. Then, if the consumer 112 confirms the transaction, the transaction request may be authenticated (again, assuming all other rules and/or requirements are met (e.g., assuming the fraud analysis at 408 is also satisfied, etc.)).

Evaluating the transaction request and/or transaction history of the associated payment account for indications of fraud (at 408) may include transmitting or otherwise communicating, by the IoT server 130, various parameters of the transaction request, payment account data of the payment account associated with the IoT device 122, or the like, to the fraud engine 134. Upon receipt, the fraud engine 134 may access transaction data associated with the IoT device 122, the IoT server 130, and/or the payment account associated with the transaction request. Further, the fraud engine 134 implements a fraud analysis that, when applied to the transaction request, provides an indication of a likelihood that the transaction request is fraudulent. The analysis is then transmitted to the IoT server 130. If the result of the analysis indicates that fraud is likely (e.g., an IP address of the transaction request does not match a location of the IoT device 122, etc.), the request for payment credentials is rejected (e.g., the transaction request is not authenticated, etc.). Alternatively, if the result of the analysis indicates that fraud is not likely, the transaction request is accepted/authenticated, assuming all other rules and/or requirements are met (e.g., assuming operation 406 is satisfied, etc.). In some embodiments, a result indicating a high chance of fraud may cause the IoT server 130 to unregister the device identifier of the IoT device 122 such that future transaction requests from the IoT device 122 will fail unless the IoT device 122 is registered with the IoT server 130 again. Further, the fraud engine 134 may blacklist the IoT device 122 (e.g., its device identifier, etc.) such that any transactions involving the IoT device 122 will be indicated as fraudulent until it can be shown that the reason for the fraud indication has been sufficiently remedied.

With continued reference to FIG. 4, when authentication of the IoT device 122 fails at 404, the IoT server 130 sends (or transmits) a transaction rejection message to the IoT device 122, at 410. In some embodiments, the IoT server 130 may also send/transmit (and/or cause to be displayed) a transaction rejection notification to the consumer 112 at his/her communication device (e.g., via SMS, email, etc.). In turn, at 412, the IoT device 122 receives the transaction rejection message and may cause a rejection alert or message to display on an interface, if such an interface is available. The IoT device 122 and/or the IoT server 130 may store the rejected transaction request in corresponding memory 204 and/or cause the rejected transaction request to be stored by another part of system 100, such as the fraud engine 134, or the like.

Alternatively, when authentication of the IoT device 122 is successful at 404, the IoT server 130 implements any identified payment preferences provided by the consumer 112, at 414 (e.g., as received from the consumer 112 at 316 in the method 300, etc.) and requests, at 416, from the payment engine 132, payment credentials for the selected payment account (based on the consumer payment preferences) that is linked to the device identifier of the IoT device 122. In connection therewith, the IoT server 130 may also compare the payment account selection to payment options supported by the merchant 102 involved in the corresponding payment account transaction to confirm that the selected payment account will be accepted by the merchant 102 (and potentially use such comparison as a factor in selecting a different payment account, as necessary). As previously described, the payment engine 132 stores payment account information for the consumer's payment account, including payment credentials, in a virtual wallet data structure or the like. Thus, upon receiving the request from the IoT server 130, the payment engine 132 retrieves the requested payment credentials from the wallet data structure, at 418. It should be understood that the interactions between the IoT server 130 and payment engine 132 may be secured by an encryption scheme or the like.

In turn, the payment engine 132 transmits the retrieved payment credentials to the IoT server 130, at 420, and the IoT server 130 transmits the payment credentials to the IoT device 122, at 422. It should be appreciated that the transmissions, at 420 and 422, may also be secured according to an encryption scheme or the like, and in some embodiments, the encryption scheme may make further use of the key assigned to the IoT device 122.

Then in the method 400, upon receiving the payment credential, the IoT device 122 performs the transaction associated with the transaction request, at 424, using the received payment credentials. With reference to the system 100, the transaction may be with the merchant 102, via the network 118, for example. The transaction, then, is generally consistent with the example transaction described above with reference to path A in FIG. 1 (be it a purchase transaction or a refund transaction). And, the authentication request generated as part of the transaction, when relating to the purchase of a product, includes a transaction record that identifies some or all of the transaction parameters of the transaction request and the received payment credentials. In addition, when the merchant 102 submits the transaction for authorization, the merchant 102 may identify the transaction as IoT originated so that the acquirer 104 can equally identify this on the payment network 106 (e.g., through the POS entry mode, etc.).

It should again be appreciated that initiating a payment account transaction with either of the IoT devices 114 and 116, via the IoT application 128, would be substantially similar to the above description. In addition, it should also be appreciated that any of the IoT devices 114, 116, and 122 may initiate a request for a refund in a similar manner to that described above and, for example, consistent with method 400.

In view of the above, the systems and methods herein enable IoT devices to be used as payment devices in payment account transactions. In so doing, the IoT devices are initially linked with desired payment accounts. Then, when the IoT devices are used to initiate a payment account transaction, they are authenticated and provided corresponding payment credentials for their linked payment accounts to complete the transaction. In this manner, the IoT devices are enabled to initiate the payment account transactions while security of the payment credentials used in the transactions is enhanced by the authentication process.

It should be appreciated that the functions described herein, in some embodiments, may be described in computer executable instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: (a) receiving, by a computing device, a transaction request associated with a merchant, the transaction request including a device identifier for an IoT device associated with a consumer and/or a location of the IoT device; (b) retrieving, by the computing device, a payment credential associated with a payment account when the transaction request is authenticated; (c) causing, by the computing device, the payment credential to be sent to the IoT device associated with the device identifier, whereby the IoT device is able to direct the merchant to proceed in the transaction using the payment credential; (d) unregistering the device identifier when fraud analysis indicates the chance of the transaction request being fraudulent is above the threshold value; and (e) authenticating the transaction request based on cryptographic data established during registration of the IoT device with the computing device.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements/features recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for enabling payment account transactions using Internet of Things (IoT) devices, the method comprising:
receiving, by a computing device, a transaction request associated with a merchant, the transaction request including a device identifier for an IoT device associated with a consumer and/or a location of the IoT device;
retrieving, by the computing device, a payment credential associated with a payment account when the transaction request is authenticated; and
causing, by the computing device, the payment credential to be sent to the IoT device associated with the device identifier, whereby the IoT device is able to direct the merchant to proceed in a transaction using the payment credential.

2. The method of claim 1, wherein the transaction request includes at least one transaction parameter; and
wherein retrieving a payment credential associated with a payment account when the transaction request is authenticated includes retrieving the payment credential associated with the payment account when the at least one transaction parameter satisfies a transaction rule.

3. The method of claim 2, wherein the transaction parameter includes a transaction amount and the transaction rule is satisfied when the transaction amount is one of greater than a threshold value, less than a threshold value, and equal to a threshold value; and/or
wherein the transaction parameter includes a merchant category code and the transaction rule is satisfied when the merchant category code is equal to a defined value.

4. The method of claim 2, wherein retrieving the payment credential associated with the payment account when the transaction request is authenticated further includes retrieving the payment credential associated with the payment account when fraud analysis indicates a chance of the transaction request being fraudulent is below a threshold value.

5. The method of claim 4, further comprising unregistering the device identifier when fraud analysis indicates the chance of the transaction request being fraudulent is above the threshold value.

6. The method of claim 1, further comprising authenticating the transaction request based on cryptographic data established during registration of the IoT device with the computing device.

7. The method of claim 6, further comprising installing, by the computing device, the cryptographic data at the IoT device.

8. The method of claim 6, wherein the cryptographic data is stored at the IoT device; and
further comprising installing updated cryptographic data at the IoT device based on the cryptographic data already stored at the IoT device.

9. The method of claim 8, wherein installing the updated cryptographic data is initiated based on one or more of a proximity of the IoT device to the computing device, a time period, and a number of transactions completed involving the cryptographic data already stored at the IoT device.

10. The method of claim 1, wherein retrieving a payment credential associated with a payment account when the device identifier is authenticated includes requesting the payment credential from a virtual wallet and receiving the requested payment credential from the virtual wallet.

11. A system for enabling payment account transactions using Internet of Things (IoT) devices having one or more functionalities other than enabling purchase of products via payment account transactions, the system comprising:
a processor; and
a memory coupled to the processor, the memory comprising processor-executable instructions that, when executed by the processor, cause the processor to:
assign a device identifier to an IoT device having one or more functionalities other than enabling purchase of products via payment account transactions;
transmit the assigned device identifier to the IoT device;
receive a transaction request from the IoT device, the transaction request including the device identifier for the IoT device; and
when the device identifier included in the transaction request is authenticated, cause a payment credential for a payment account to be delivered to the IoT device, whereby the IoT device can be used as a payment device for the payment account to initiate a payment account transaction to the payment account.

12. The system of claim 11, wherein the processor-executable instructions, when executed by the processor, further cause the processor to:
solicit and receive at least one payment preference associated with the IoT device from a user; and
solicit and receive at least one transaction rule associated with the IoT device from the user.

13. The system of claim 12, wherein the at least one payment preference includes a payment account selection associated with the payment credential; and
wherein the processor-executable instructions, when executed by the processor, further cause the processor to compare the payment account selection associated with the at least one payment preference to payment options supported by a merchant involved in the payment account transaction.

14. The system of claim 12, wherein the transaction request includes at least one transaction parameter; and
wherein the processor-executable instructions, when executed by the processor, further cause the processor to authenticate the device identifier included in the transaction request by, at least, evaluating the at least one transaction rule based on the at least on transaction parameter.

15. The system of claim 14, wherein the processor-executable instructions, when executed by the processor in connection with evaluating the at least one transaction rule, further cause the processor to compare the at least one transaction parameter to a threshold value.

16. The system of claim 11, further comprising the IoT device having one or more functionalities other than enabling purchase of products via payment account transactions, the IoT device including a memory storing processor-executable instructions which, when executed by a processor, cause the IoT device to:
receive a device identifier that identifies the IoT device;
cause a transaction request to be delivered, wherein the transaction request includes the device identifier; and
when a payment credential is received at the IoT device in response to the transaction request, initiate a payment account transaction associated with the transaction request, wherein the payment account transaction includes the payment credential; and

17. A non-transitory computer readable storage media including computer executable instructions for enabling payment transactions using Internet of Things (IoT) devices that, when executed by a processor, cause the processor to:
receive a transaction request including an IoT device identifier, a message authentication code associated with cryptographic material, and at least one transaction parameter associated with at least one transaction rule;
when the IoT device identifier is authenticated, the transaction request is validated, and the at least one transaction parameter satisfies the at least one transaction rule, request a payment credential based on the IoT device identifier;
receive the requested payment credential; and
cause the received payment credential to be transmitted to an IoT device associated with the IoT device identifier.

18. The non-transitory computer readable storage media of claim 17, wherein the executable instructions, when executed by the processor, further cause the processor to:
access stored device identifiers associated with registered IoT devices; and
authenticate the IoT device identifier when the IoT device identifier matches one of the stored device identifiers.

19. The non-transitory computer readable storage media of claim 17, wherein the at least one transaction rule is satisfied when the at least one transaction parameter is one of greater than a threshold value, less than the threshold value, or equal to the threshold value.

20. The non-transitory computer readable storage media of claim 17, wherein the at least one transaction parameter includes a location of the IoT device associated with the IoT device identifier, and the at least one transaction rule is satisfied when the location of the IoT device is within a threshold distance of a pre-defined location.
